(19) United States
(12) Patent Application Publication
(10) Pub. No.: US 2013/0297086 A1
(43) Pub. Date: Nov. 7, 2013

(54) POWER-SAVING CONTROLLING METHOD AND SYSTEM THEREOF

(71) Applicants: Kun-Lin TSAI, Taichung City (TW); Da-Wei TSAI, Taipei City (TW); Chiun-Luen TZENG, Tainan City (TW); Bo-Hao SU, Kaohsiung City (TW); Li-Wen LAI, Taichung City (TW)

(72) Inventors: Kun-Lin TSAI, Taichung City (TW); Da-Wei TSAI, Taipei City (TW); Chiun-Luen TZENG, Tainan City (TW); Bo-Hao SU, Kaohsiung City (TW); Li-Wen LAI, Taichung City (TW)

(73) Assignee: TUNGHAI UNIVERSITY, TAICHUNG CITY (TW)

(21) Appl. No.: 13/612,807

(22) Filed: Sep. 12, 2012

(30) Foreign Application Priority Data
May 3, 2012 (TW) 101115790

(51) Int. Cl. G06F 1/32

(52) U.S. Cl. 700/291; 700/297

(57) ABSTRACT

A power-saving controlling method includes steps as follows. An electrical information is captured from an electrical equipment by an intelligent socket device. The electrical information is calculated and a rule table is generated. An automatic controlling signal is generated according to the rule table. The intelligent socket device is switched off or switched on according to the automatic controlling signal.

### RELATED APPLICATIONS

The application claims priority to Taiwan Application Serial Number 10115790, filed May 3, 2012, which is herein incorporated by reference.

### BACKGROUND

1. Technical Field

The present disclosure relates to power-saving controlling methods and systems thereof. More particularly, the present disclosure relates to power-saving controlling methods for standby power and systems thereof.

2. Description of Related Art

Non-renewable energy resources such as coal, petroleum and natural gas are consumed much faster than nature can create them, while the demand for energy is keep growing. Once the non-renewable energy resources are depleted, there is no more available for future needs. How to save energy efficiently has become a global concern.

Accordingly, many appliances are equipped with power-saving controlling components such as inverters, high efficiency motors and/or compensation capacitors. For example, an inverter air conditioner is an air conditioner equipped with an inverter, which controls the temperature by improving the operation method of the compressor, such as changing the rotation speed of the compressor, rather than switching off and switching on the compressor. However, the power-saving controlling components are only suitable for new and costly appliances, which are usually too expensive to afford. As for the old appliances which the users have already owned, there is still no applicable method for reducing power consumption.

Being an alternative method for saving power, intelligent power-saving controlling systems are provided by the manufacturers. The intelligent power-saving controlling systems control the power consumption system by computers combined with programs and equipments such as sensors. For example, an intelligent power-saving controlling system for an air-conditioning system can gather the information of the space applied the air-conditioning system by sensors. The information includes the number of persons in the space, the ambient air temperature, the usage time of the space, and so on. The program calculates the information and provides a schedule for the air-conditioning system. Specifically, the usage states of a meeting room and an office are quite different, thus the information gathered from a meeting room is different from an office, the program calculates the information and provides each the meeting room and the office a tailor-made schedule. The schedule includes the operation time, the temperature, the air volume and the predetermined power consumption of the air-conditioning system. As long as the power consumption reaches the predetermined value, the air-conditioning system is switched off automatically.

However, whether the schedule is practicable depends on the amount of information. Thus a large number of sensors are needed for gathering sufficient information. The expense for purchasing the sensors and the power consumption of the sensors are costly.

The aforementioned methods save power by improving the hardware of appliances or controlling the appliances via programs. Both methods neglect the consumption of standby power. In general, when an electrical equipment is plugged into a socket, the electrical equipment continues to consume power even after being switched off. Standby power refers to the power consumed by electrical equipments while they are switched off. According to the survey of the International Energy Agency, in advanced countries, the amount of standby power consumption is 3% to 11% of total household power consumption. The standby power consumption has become one of the fast-growing items in household power consumption.

### SUMMARY

According to an aspect of the present disclosure, a power-saving controlling method includes steps as follows. An electrical information is captured from an electrical equipment by an intelligent socket device. The electrical information is calculated and a rule table is generated. An automatic controlling signal is generated according to the rule table. The intelligent socket device is switched off or switched on according to the automatic controlling signal.

According to another aspect of the present disclosure, a power-saving controlling system includes an intelligent socket device and a learning controlling device. The intelligent socket device is for connecting to an electrical equipment and capturing an electrical information from the electrical equipment. The learning controlling device is connected to the intelligent socket device and includes a communication module, a memory module, a learning module, and a controlling module. The communication module is for receiving the electrical information of the intelligent socket device. The memory module is for recording the electrical information. The learning module is for calculating the electrical information and generating a rule table. The controlling module is for controlling the intelligent socket device, wherein the controlling module includes an automatic module for generating an automatic controlling signal to the intelligent socket device via the communication module, and the automatic controlling signal is generated according to the rule table.

### BRIEF DESCRIPTION OF THE DRAWINGS

The disclosure can be more fully understood by reading the following detailed description of the embodiment, with reference made to the accompanying drawings as follows:

FIG. 1 is a functional block showing a power-saving controlling system according to one embodiment of the present disclosure;

FIG. 2 is a flow diagram of a power-saving controlling method according to another embodiment of the present disclosure; and

FIG. 3 is a functional block showing a power-saving controlling system according to yet another embodiment of the present disclosure.

### DETAILED DESCRIPTION

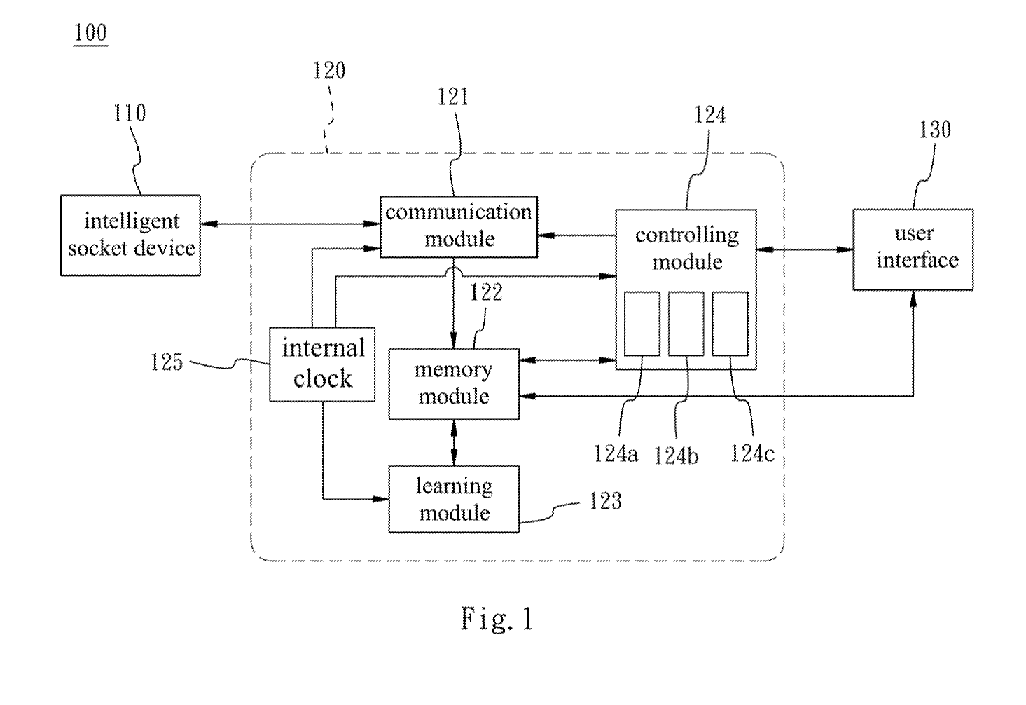

FIG. 1 is a functional block showing a power-saving controlling system 100 according to one embodiment of the present disclosure. In FIG. 1, the power-saving controlling system 100 includes an intelligent socket device 110, a learning controlling device 120, and a user interface 130. The learning controlling device 120 is connected to the intelligent socket device 110, and the user interface 130 is connected to the learning controlling device 120.

The intelligent socket device 110 is for connecting to an electrical equipment and capturing an electrical information from the electrical equipment. The electrical information includes an average voltage, an average current, a total power, and so on.

The aforementioned term “intelligent socket device” means a socket equipped with a miniature electric meter, thus the intelligent socket device 110 can capture the electrical information from the electrical equipment.

The learning controlling device 120 is connected to the intelligent socket device 110 and includes a communication module 121, a memory module 122, a learning module 123, and a controlling module 124. The communication module 121 is for receiving the electrical information of the intelligent socket device 110. The communication module 121 can be wireless or wired, such as a Zigbee wireless network. The memory module 122 is for recording the electrical information. The learning module 123 is for calculating the electrical information recorded in the memory module 122 and generating a rule table. The rule table can be a power consumption prediction for the intelligent socket device 110. In other words, the rule table can be the power consumption prediction of the electrical equipment connected to the intelligent socket device 110. The learning module 123 can calculate the electrical information by a learning algorithm. The learning algorithm is but not limited to a neural network algorithm, a genetic algorithm, or a fuzzy algorithm.

For an example, the learning algorithm is the neural network algorithm, which keeps modifying the rule table according to the renewing electrical information, as a result, the rule table is tailor-made for a user's electricity-using habit. For most users, the electricity-using habit on weekdays is quite different from the habit on weekends. The learning module 123 can calculate the electrical information of the weekdays and weekends respectively, and generates a weekdays' rule table and a weekends' rule table. Furthermore, the user's electricity-using habit is usually dynamic and varies gradually. The learning module 123 can calculate a weighted value of the electrical information according to the dates, the closer the dates, the greater the weights. Accordingly, the rule table corresponds to the user's electricity-using habit.

The controlling module 124 is for controlling the intelligent socket device 110. The controlling module 124 includes an automatic module 124b and a manual module 124c. The automatic module 124b is for generating an automatic controlling signal to the intelligent socket device 110 via the communication module 121. The automatic controlling signal is generated according to the rule table and is for switching off or switching on the intelligent socket device 110. The manual module 124c is for generating a manual controlling signal to the intelligent socket device 110 via the communication module 121. The manual controlling signal is for switching off or switching on the intelligent socket device 110.

The user interface 130 is connected to the learning controlling device 120. The user can control the learning controlling device 120 and the intelligent socket device 110 via the user interface 130. For example, the user can drive the automatic module 124b or the manual module 124c, set a predetermined power consumption for the intelligent socket device 110, etc. Furthermore, the user can read the electrical information recorded in the memory module 122 and switch off the power-saving controlling system 100 via the user interface 130.

In one example, the rule table is provided from the learning controlling device 120 according to the user's electricity-using habit, such as that the user do not use electricity from 8:00 A.M. to 5:00 P.M. Therefore, the automatic module 124b generates the automatic controlling signal to switch off the intelligent socket device 110 at 8:00 A.M. and then generates the automatic controlling signal again to switch on the intelligent socket device 110 at 5:00 P.M. Moreover, if the user plans a trip for three days, which means the user does not need to use electricity in the three days. The user can drive the manual module 124c via the user interface 130 before leaving, then the manual controlling signal is generated by the manual module 124c to switch off the intelligent socket device 110 and then to switch on the intelligent socket device 110 after the user returning home. The manual module 124c is superior to the automatic module 124b, so that the user can control the intelligent socket device 110 flexibly.

In FIG. 1, the memory module 122 can also record the table rule, the automatic controlling signal, the manual controlling signal, the predetermined power consumption set by the user, and so on.

The controlling module 124 further includes a warning unit 124a for generating a warning signal. For example, when the electrical information captured by the intelligent socket device 110 is abnormal, the intelligent socket device 110 may be led to short circuit or generated a fault. At the same time, the warning signal is generated from the warming unit 124a and displayed on the user interface 130. Therefore, the user can be reminded that the intelligent socket device 110 might be abnormal and needed to he repaired or replaced. Moreover, the user can set the predetermined power consumption for the intelligent socket device 110 in advance. Once the power consumption reaches the predetermined power consumption, the warning signal is generated, so as to remind the user to switch off the intelligent socket device 110.

The learning controlling device 120 can further include an internal clock 125 for triggering the communication module 121 the learning module 123 and the controlling module 124 at a predetermined time interval. For example, the internal clock 125 triggers the communication module 121 and the controlling module 124 every 10 minutes, i.e., the predetermined time interval is 10 minutes. Moreover, at 0 o'clock in the morning, the internal clock 125 triggers the learning module 123 to calculate the electrical information and generate the rule table. The rule table is the power consumption prediction for the intelligent socket device 110 of the day.

Practically, the power-saving controlling system 100 can run for a predetermined time in advance, so that the memory module 122 can record sufficient electrical information. The more the electrical information is collected, the rule table generated by the learning module 123 is closer to the user's electricity-using habit. In another example, the memory module 122 can record 30 days' electrical information.

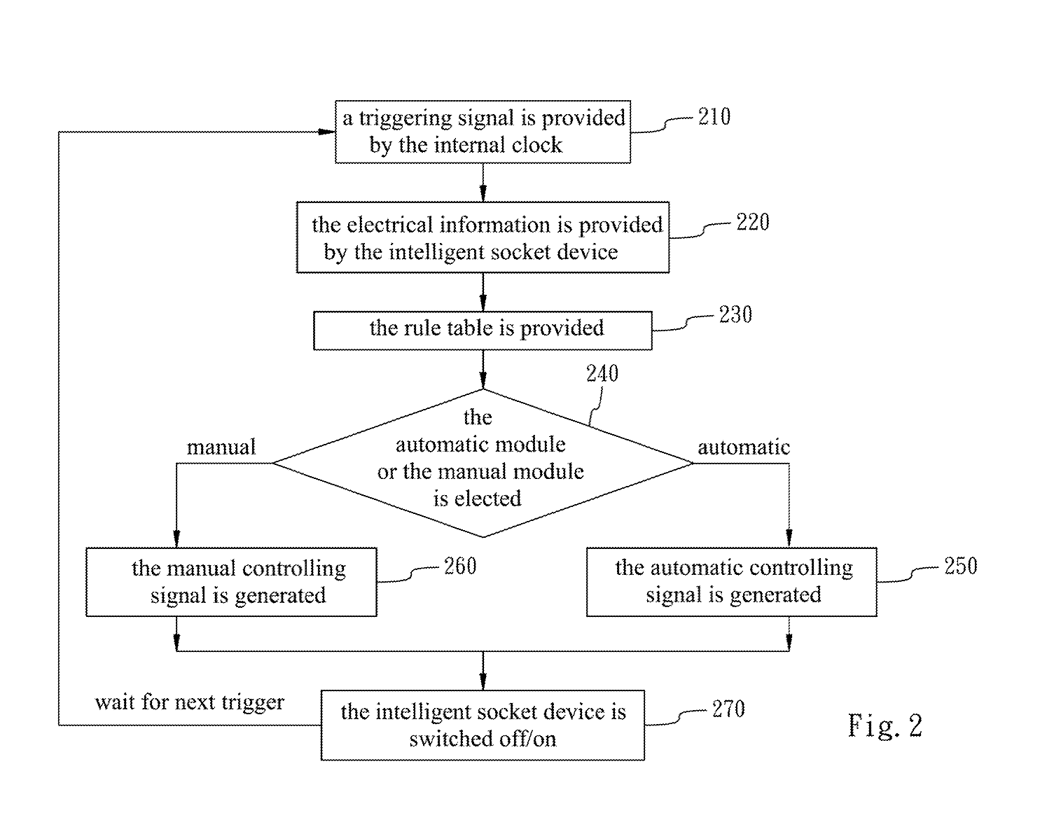

FIG. 2 is a flow diagram of a power-saving controlling method according to another embodiment of the present disclosure, which is for utilizing the power-saving controlling system 100 in FIG. 1.

In FIG. 2, the power-saving controlling method includes steps as follows. In Step 210, a triggering signal is provided by the internal clock 125. The communication module 121 receives the triggering signal and requests the intelligent socket device 110 to provide the electrical information. In Step 220, the electrical information is provided, wherein the electrical information is captured from an electrical equipment by the intelligent socket device 110. In Step 230, the rule table is provided. The rule table is generated by the learning module 123. In Step 240, the automatic module 124b or the manual module 124c is elected In Step 250, when the automatic module 124b is elected in Step 240, the automatic controlling signal can be generated according to the rule table. In Step 260, when the manual module 124c is elected in Step 240, the manual controlling signal can be generated. In Step 270, the intelligent socket device 110 is switched off or switched on. Afterward, wait for next trigger.

The details of the power-saving controlling method in FIG. 2 are described as follows, which is combined with FIG. 1.

In Step 210, a triggering signal is provided by the internal clock 125 every 10 minutes. In other words, every 10 minutes is referred to as a time period. In FIG. 1, the communication module 121 receives the triggering signal and requests the intelligent socket device 110 to provide the electrical information in the nearest 10 minutes.

In Step 220, the electrical information is provided by the intelligent socket device 110. In FIG. 1, the communication module 121 receives then sends the electrical information to the memory module 122. The electrical information includes an average voltage, an average current, and a total power in the 10 minutes. The electrical information is recorded by the memory module 122.

In Step 230, the rule table is provided, wherein the rule table is recorded in the memory. In FIG. 1, the learning module 123 receives the triggering signal at 0'oclock. The learning module 123 calculates the electrical information recorded in the memory module 122, and generates the rule table. The rule table is the power consumption prediction for the intelligent socket device 110 for each time period of the day. Afterward, the rule table is sent to the memory module 122 and then be recorded in the memory module 122.

In Step 240, the automatic module 124b or the manual module 124c is elected.

In Step 250, when the automatic: module 124b is elected in Step 240, the automatic controlling signal can be generated according to the rule table. In FIG. 1, the automatic module 124b recalls the power consumption prediction for the present time period in the rule table and the real-time electrical information from the memory module 122. The automatic controlling signal is generated according to the aforementioned power consumption prediction and the real-time electrical information. Then the automatic controlling signal is provided to the intelligent socket device 110 via the communication module 121.

In Step 260, when the manual module 124c is elected in Step 240, the manual controlling signal can be generated by the manual module 124c. In FIG. 1, the manual module 124c is drove by the user via the user interface 130 in advance. The manual module 124c recalls the real-time electrical information from the memory module 122. Then the manual controlling signal is generated by the memory module 122 and provided to the intelligent socket device 110 via the communication module 121.

In Step 270, the intelligent socket device 110 is switched off or switched on. Afterward, wait for next trigger.

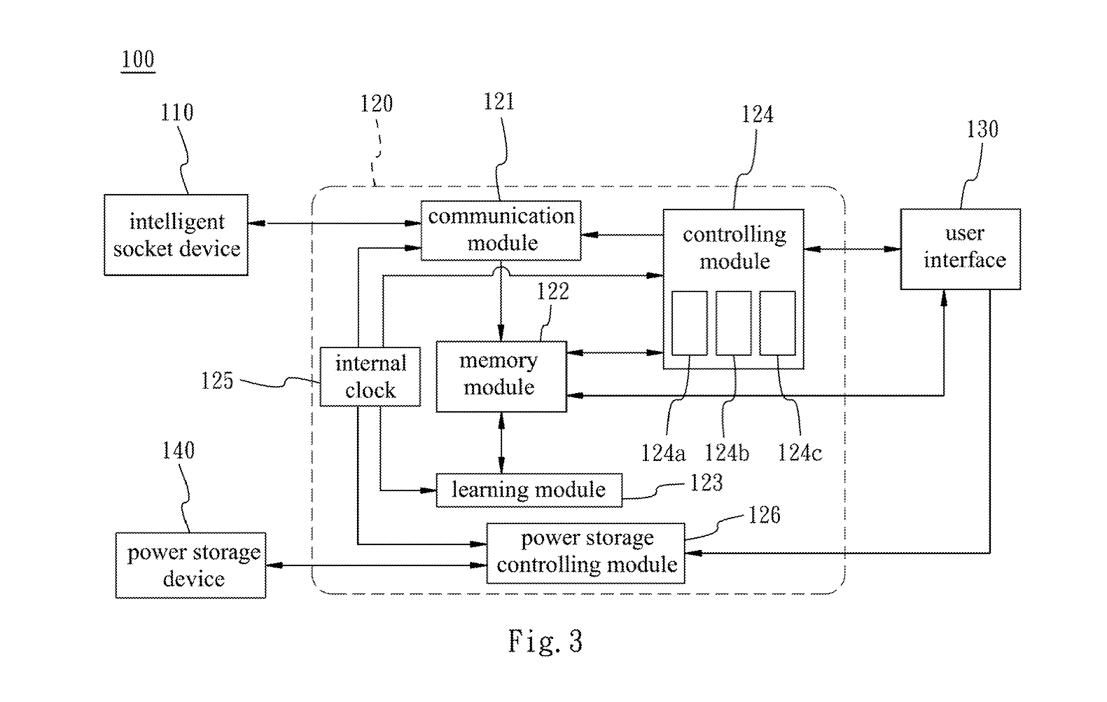

FIG. 3 is a functional block showing a power-saving controlling system 100 according to yet another embodiment of the present disclosure. In FIG. 3, the power-saving controlling system 100 further includes a power storage device 140, and the learning controlling device 120 further includes a power storage controlling module 126. The power storage device 140 can include a battery and a charge and discharge controller. During a peak power period or a power failure period the power storage device 140 can be an alternative power supply for the power-saving controlling system 100. The power storage controlling module 126 can be triggered by the internal clock 125 at the predetermined time interval. After triggering, the power storage controlling module 126 captures an information from the power storage device 140 and provides a control signal to the power storage device 140. The user can read the information or input the control signal via the user interface 130. The information can be the amount of power stored in the power storage device 140. The control signal can switch on or switch off the power storage device 140.

Therefore, the power-saving controlling system can be utilized based on the user's habit. The learning module calculates the electrical information and generates the rule table that is tailor-made for the user. The automatic module can generate the automatic controlling signal to switch off the unused intelligent socket device automatically. Thus, the standby power consumption can be reduced efficiently and conveniently. Also, the user can control the power-saving controlling system via the user interface, which means the power-saving controlling system is flexible and convenient for the user.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fail within the scope of the following claims.

What is claimed is:

1. A power-saving controlling method, comprising:
capturing an electrical information from an electrical equipment by an intelligent socket device;
calculating the electrical information and generating a rule table;
generating an automatic controlling signal according to the rule table; and
switching off or switching on the intelligent socket device according to the automatic controlling signal.

2. The power-saving control method of claim 1, wherein the rule table is generated by calculating the electrical information by a learning algorithm.

3. A power-saving controlling system, comprising:
an intelligent socket device for connecting to an electrical equipment and capturing an electrical information from the electrical equipment; and
a learning controlling device connected to the intelligent socket device, comprising:
a communication module for receiving the electrical information of the intelligent socket device;
a memory module for recording the electrical information;
a learning module for calculating the electrical information and generating a rule table; and
a controlling module for controlling the intelligent socket device, wherein the controlling module comprises an automatic module for generating an automatic controlling signal to the intelligent socket device via the communication module, and the automatic controlling signal is generated according to the rule table.

4. The power-saving controlling system of claim 3, wherein the controlling module comprises a manual module for generating a manual controlling signal, and the power-saving controlling system comprises a user interface for driving the automatic module or the manual module.

5. The power-saving controlling system of claim 4, wherein the manual controlling signal is for switching off or switching on the intelligent socket device.

6. The power-saving controlling system of claim 3, wherein the learning controlling device comprises an internal clock for triggering the communication module, the learning module, and the controlling module at a predetermined time interval.

7. The power-saving controlling system of claim 3, wherein the communication module is wireless or wired.

8. The power-saving controlling system of claim 3 wherein the memory module records the rule table, and the automatic controlling signal.

9. The power-saving controlling system of claim 3, wherein the learning module calculates the electrical information by a learning algorithm.

10. The power-saving controlling system of claim 3, wherein the controlling module comprises a warning unit for generating a warning signal.

11. The power-saving controlling system of claim 3, wherein the automatic controlling signal is for switching off or switching on the intelligent socket device.

12. The power-saving controlling system of claim 3, wherein the electrical information comprises an average voltage, an average current, and a total power.

13. The power-saving controlling system of claim 3, wherein the rule table is a power consumption prediction for the intelligent socket device.

14. The power-saving controlling system of claim 3, further comprising:
a power storage device which comprises a battery and a charge and discharge controller.

15. The power-saving controlling system of claim 14, wherein the learning controlling device comprises a power storage module.
